(19) United States
(12) Patent Application Publication
(10) Pub. No.: US 2001/0036126 A1
(43) Pub. Date: Nov. 1, 2001

(54) Stepwise mixing intensity reduction and mixer/settler separation process

(76) Inventors: Ye-Mon Chen, Sugar Land, TX (US); Richard Gelles, Houston, TX (US)

Correspondence Address: Shell Oil Company, Legal - Intellectual Property, P.O. Box 2463, Houston, TX, 77252-2463, US

(21) Appl. No.: 09/799,243

(22) Filed: Mar. 5, 2001

Related U.S. Application Data
(60) Provisional application No. 60/187,602, filed on Mar. 7, 2000.

(51) Int. Cl. B01F 3/00

(52) U.S. Cl. 366/348; 366/317

(57) ABSTRACT

A method for improving extraction and separation of a component from a fluid. The method comprises forming a multi-phase fluid system, the multi-phase fluid system comprising at least a first phase having at least one extractable component and a second phase having an attraction for the extractable component, mixing the multi-phase fluid system at a first mixing intensity, mixing the multi-phase fluid system at least a second mixing intensity less than the first mixing intensity, and allowing the multi-phase fluid system to settle. In this process, the mixing intensity is reduced step-wise, resulting in lower entrainment of the extractable component in the fluid and faster separation of the phases.

### BACKGROUND OF THE INVENTION

1. Field of the Invention

The present invention relates to mixing and phase separation techniques in multi-phase systems. More particularly, the invention relates to a mixing process that enhances extraction and separation of immiscible fluids in a two-phase system.

2. Background of the Related Art

A mixer/settler is the most commonly used equipment for extraction and separation of immiscible fluids throughout the petrochemical industry. Extraction is performed to recover a desired product or to remove undesirable impurities from a fluid system. Common extraction involves multi-phase systems formed by placing a first fluid containing the component to be extracted (the extractive component) in direct contact, usually by high intensity mixing, with a second fluid (the extraction fluid) which attracts or traps the extractive component, thereby reducing the level of that component in the first fluid. The two fluids are usually immiscible fluids such as an organic and an inorganic phase, which typically form a two-phase mixture and require intimate and thorough mixing to achieve a good extraction. The mixing process is then discontinued and the phases of the mixture are allowed to separate out gradually under gravity in the mixer/settler. However, extraction and separation by conventional methods can have fluid systems with entrained phases of the extraction fluid in the fluid which is being acted upon. The entrained phases contain the very components that are meant to be extracted from the first fluid and can lead to processes having ineffective extractions and/or lengthy settling times to separate the phases.

Effective and rapid extraction and separation of immiscible fluids by a mixer/settler is vitally important in polymer production. Polymers that are either elastomeric or non-elastomeric in general properties may be synthesized in solution by the use of polymerization initiators and catalysts. Catalysts may also be introduced during a subsequent treatment of the polymer, such as hydrogenation of an unsaturated polymer; to produce a polymer with desired compositions and properties. The initiators and catalysts are typically metal and organometallic compounds that are not consumed in the polymer production process and often remain in the polymer solution, or polymer cement, as polymer residue. As polymer residue, initiators and catalysts can frequently accelerate deterioration of the polymer, detrimentally affect polymer properties, such as color, and may interfere with subsequent reactions, such as epoxidation.

To ensure the purity of the polymer, the polymer residue is extracted from the polymer solution by reacting the polymer residue with a reagent within an inorganic phase, thereby forming a product that can then be separated. Generally, the product will be insoluble in the polymer solution, an organic phase, and may be removed from the organic phase by an extraction mechanism to an inorganic phase. The reagent used to form an extractable product in the inorganic phase is typically a mineral acid but may also include organic acids, such as carboxylic acids, peracids, carbonic acid from the reaction of carbon dioxide and water, or caustics. For example, a peracid solution and a caustic solution are used to concurrently epoxidize and extract catalyst residue from a polymer and are disclosed in U.S. patent application Ser. No. 5,543,472, which is incorporate herein by reference to the extent not inconsistent with the invention.

However, as effective as extraction processes are in reducing the amount of polymer residue remaining in the polymer after treatment, the extraction processes for polymers and other processes are not effective in removing all of the polymer residue. In some processes, more polymer residue in the polymer is retained than is desired for many end uses of the polymer. Moreover, extraction processes involving the use of an aqueous solution as the inorganic phase generally have high concentrations of polymer residue in the polymer due to entrainment of the aqueous solution in the organic, polymer cement phase.

A separation or gravity settling step is often used after an extraction process to further allow polymer residue extraction and to reduce the amount of entrainment in the two-phase mixture. However, in many production processes the settling process is often very slow and often becomes the limiting production step, or bottleneck, of the production process. Additionally, the final separation often retains residue because fine entrained materials do not settle out or require settling times incompatible with production needs, thereby producing products with high levels of contaminants.

Further, the mixing approach of the multi-phase mixture can have a significant effect on the amount of extraction and entrainment in the phases as well as the length of time needed to separate the phases. For example, mixing is conventionally performed in two approaches, high intensity mixing and low intensity mixing. High intensity mixing allows for fast extraction of materials between the two immiscible fluids, but is slow to separate or settle and often contains high entrainment of materials meant to be extracted. Low intensity mixing has a slow extraction process, but separates much faster and has a comparably low entrainment compared to high intensity mixing. The mechanisms of low intensity and high intensity mixing are not fully understood, and seem to provide mutually exclusive mechanisms and results. Currently there remains a need for a method for mixing multi-phase systems that provides rapid extraction and rapid separation of two immiscible fluids with minimal entrainment.

### SUMMARY OF THE INVENTION

The present invention provides a method for improving extraction and separation in a multi-phase fluid system. In one aspect, the invention provides a method for extracting and separating extractive components from a multi-phase fluid system, comprising forming a multi-phase fluid system, where the multi-phase fluid system includes at least a first phase having at least one extractable component and at least a second phase having an attraction for the extractable components, mixing the multi-phase fluid system at a first mixing intensity, mixing the multi-phase fluid system at least at a second mixing intensity less than the first mixing intensity, and allowing the multi-phase fluid system to settle.

Mixing of the multi-phase system by the step-wise reduction mixing process provides surprising and unexpected results, where the multi-phase system has a faster than expected separation and extraction with a lower than expected entrainment of components. The method may further comprise mixing the multi-phase fluid system at a third mixing intensity less than the second mixing intensity and still further comprise mixing the multi-phase fluid system at a fourth mixing intensity less than the third mixing intensity before allowing the multi-phase fluid system to settle. The mixing method can be performed in a batch or continuous process and may also be performed by one or more variable or constant rate mechanically agitated mixer, one or more in-line mixing elements, or combinations of both. Time for a continuous process refers to residence time, e.g., volume of equipment divided by flow rate.

Another aspect of the invention provides a method for extracting and separating impurities from polymer cements, comprising introducing a polymer cement to a vessel, contacting the polymer cement with an extraction fluid, thereby creating a two-phase extraction fluid and polymer cement mixture, mixing the two-phase mixture at a first mixing intensity, mixing the two-phase mixture at least at a second mixing intensity less than the first mixing intensity, and allowing the two-phase mixture to settle. The polymer cement preferably comprises a conjugated diene polymer having a number average molecular weight from about 1000 to about 250,000. The conjugated diene polymer may comprise a block copolymer of monovinyl aromatic and conjugated diene. Preferably, the two-phase mixture has an extraction fluid to cement volume ratio of about 0.1 to about 1.0, and the extraction fluid is preferably selected from an acid, a caustic, and combinations thereof.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1A is a schematic diagram of one embodiment of an exemplary mixer/settler in which the process of the present invention can be performed;

FIG. 1B is a schematic diagram of a flat blade impeller useful in the mixer/settler of FIG. 1A;

FIG. 2A is a schematic view of one embodiment of a mixing system using a mixing vessel, a static mixer, and a settler to perform the process of the invention; and

FIG. 2B is a schematic view of another embodiment of a mixing system using a mixing vessel, multiple stage mixers, and a settler to perform the process of the invention.

### DETAILED DESCRIPTION OF THE PREFERRED EMBODIMENT

The method for extraction and separation described herein may be performed on any multi-phase fluid system. Fluid is understood to mean a fluid or a slurry and a multi-phase system may consist of fluid, or slurry, or both. The viscosity of the fluid system merely changes the initial mixing intensity, mixing time, and/or settling time but not the process of the invention.

To practice the extraction and separation process, a multi-phase fluid system is formed comprising at least a first phase having at least one extractable component and a second phase having an attraction for the extractable component. The multi-phase system is mixed at a first mixing intensity that ensures the first fluid phase and the extraction fluid phase have good communication for the extraction of materials entrained in one of the immiscible fluids. The multi-phase solution is then mixed at least at a second mixing intensity less than the first mixing intensity. The mixing is discontinued and the multi-phase fluid system is allowed to settle and separate. The method may further comprise mixing the multi-phase fluid system at a third mixing intensity less than the second mixing intensity and still further comprise mixing the multi-phase fluid system at a fourth mixing intensity less than the third mixing intensity before allowing the multi-phase fluid system to settle.

It has been discovered by the inventors that reducing the mixing intensity in a step-wise fashion provides surprising and unexpected efficient extraction of material between phases while minimizing the entrainment of extraction fluid in the first phase which allows for a settling time that can be substantially reduced from conventional extraction and separation methods.

The present invention can be practiced with any mixer, or combinations of mixers, that provide both high mixing intensity and low mixing intensity. Mixing intensity is understood to mean any quantitative measure of degree of mixing, such as tip rate for conventional mixers or power dissipation in the region of a mixing device in general. The latter has been proven to be generally applicable to different types of mixers, such as different types of impellers, as well as in-line mixing elements, such as static mixers, by J. T. Davis in Chemical Engineering Science volume 42, 1987, pages 1671-1676. Some examples of mixers used in commercial liquid fluid/liquid fluid extraction processes are given in Handbook of Separation Techniques for Chemical Engineers, Third Edition, P. A. Schweitzer editor, McGraw Hill, 1997, pages 1-449 through 1-518. While the following description illustrates one embodiment of the invention regarding the step-wise mixing of two-phase system in a batch process using a multi-speed mixer, the embodiment is not to be construed as limiting the invention.

The first phase is preferably an organic phase, such as a polymer cement, and the second phase is preferably an immiscible inorganic phase, such as an aqueous extraction fluid comprising an acid, a caustic, and combinations thereof. The step-wise reduction of mixing intensity is obtained by the step-wise reduction of rate of the multi-speed mixer. The step-wise reduction in mixer rate is preferably performed on the two-phase mixture at a first impeller tip rate between about 25 rpm and about 3000 rpm for between about 1 minute and about 60 minutes. Then, the two-phase mixture is mixed at least at a second impeller tip rate between about 20% and about 90% of the first rate, preferably between about 40% and about 80% of the first rate, for between about 0.5 minutes and about 20 minutes. The method may further comprise mixing the multi-phase fluid system at a third rate less than the second rate and still further comprise mixing the multi-phase fluid system at a fourth rate less than the third rate before allowing the two immiscible fluids to settle.

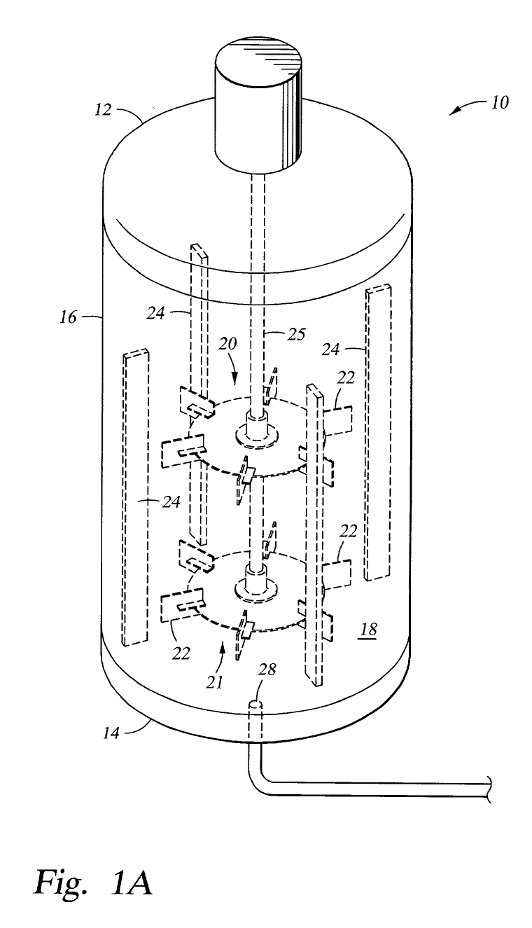

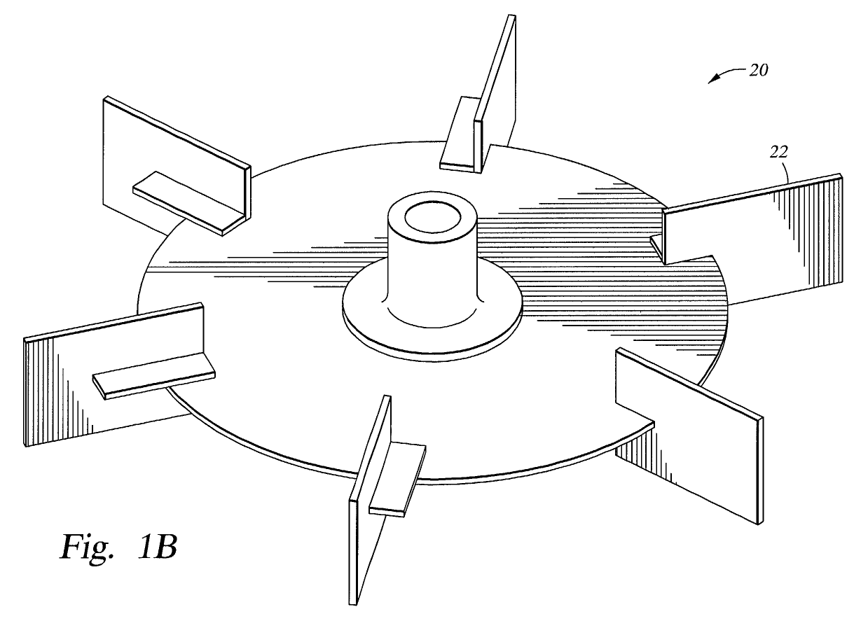

FIG. 1A is one embodiment of an exemplary mixer/settler in which the process of the present invention can be performed. The mixer/settler is a vessel 10 having a bottom 14, a cylindrical wall 16 extending vertically from the bottom 14, and a lid 12 mounted on the wall 16 and forming a sealable enclosure 18. Preferably, the vessel 10 is constructed from aluminum, steel, or any suitable material to perform the process according to the invention.

Disposed in the enclosure 18 of the vessel 10 are two flat blade impellers 20, 21 mounted on a single motor driven shaft 25 in a vertically spaced relationship from one another. A preferred flat blade impeller is shown in more detail in FIG. 1B. The impellers 20, 21 most preferably have six blades 22.

Communication between the phases may be accomplished by using a vessel 10 that contains a baffling system, such as several longitudinally oriented baffles 24 placed radially at intervals around the inner circumference of the vessel. Preferably four baffles 24 are used and located on a horizontal plane 90 degrees from one another on the wall 16 of the vessel 10 to provide for enhanced mixing during processing. Fluids are also introduced to the vessel via an inlet 28 disposed below the bottom impeller 21, and extending from the bottom 14 of the vessel 10.

While the above exemplary mixer/settler is described as dimensionless, the invention contemplates the use of settler and mixer having variable dimension since the dimensions of the mixer/settler and its components can change the initial mixing intensity, mixing time, and/or settling time while still performing the process of the invention. For example, the process of the invention can be performed on lab scale equipment as well as commercial scale equipment. Lab scale equipment generally requires higher impeller tip rpm to achieve high mixing intensity and fast extraction with a rapid settling time in comparison to commercial scale equipment where the impeller tip rpm is generally 1/10^{th} to 1/100^{th} that of lab equipment impeller tip rpm to achieve high mixing intensity, and has longer settling times due to the larger volume of processed material.

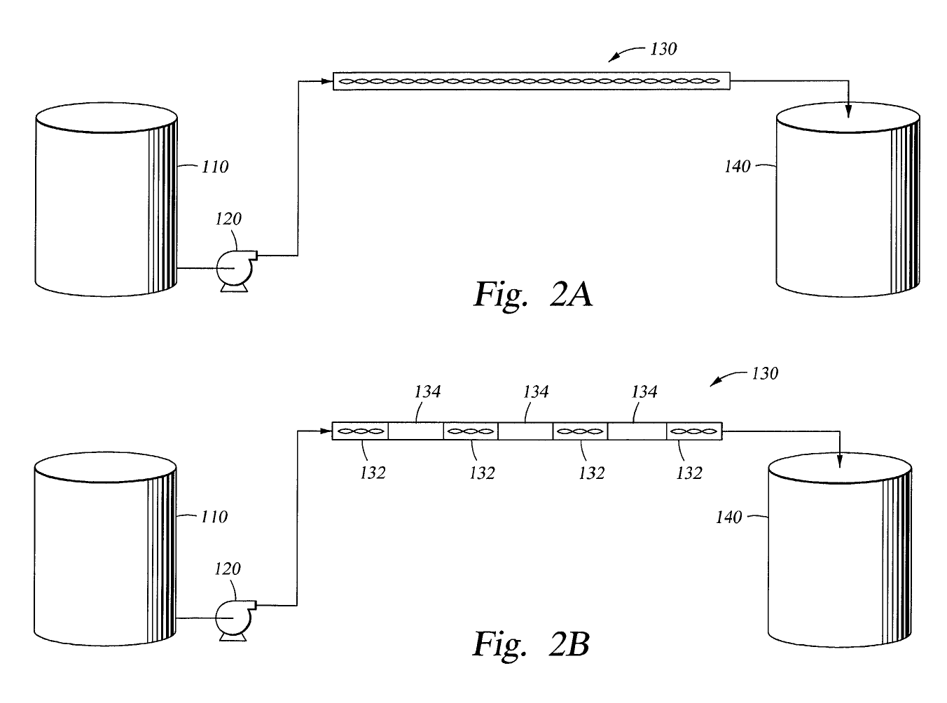

FIG. 2A is a schematic view of one embodiment of a mixing system 100 using a static mixer to perform the process of the invention. The mixing system 100 generally comprises a mixing vessel 110, a pump 120, a static mixer 130 and a settler vessel 140. Fluids are introduced into the system via the mixing vessel 110 where the multi-phase fluid system is formed comprising at least a first phase having at least one extractable component and a second phase having an attraction for the extractable component. The mixing vessel 110 preferably comprises a mixer; for example a mixer similar to the vessel 10 described in FIGS. 1A and 1B.

The multi-phase fluid system is preferably flowed through the static mixer 130 via a pump 120, and is deposited in settler 140. Alternatively, the multi-phase fluid system may be delivered to the static mixer 130 without using a pump 120 by pressurizing the mixing vessel 110 with an inert gas, such as nitrogen, or by other steps that provide a pressure differential between the mixing vessel 110 and the settler 140, to force the liquid from the mixing vessel 110 through the static mixer 130 before it is deposited in the settler 140. With this configuration, the multi-phase fluid system may be mixed at one mixing intensity in the mixing vessel 110, and mixed at a second mixing intensity less than the first mixing intensity in the static mixer 130. Alternatively, the static mixer 130 may comprise multiple static mixer segments (not shown) or other types of in-line mixing elements, such as orifice plates, placed back to back in series to provide different zones of decreasing mixing intensities within the static mixer 130.

FIG. 2B is a schematic view of another embodiment of a mixing system 100 using multiple stage static mixers to perform the process of the invention. The static mixer 130 comprises static mixer segments 132 separated by open pipes 134. A preferred order includes one static mixer, one open pipe, one static mixer, one open pipe, one static mixer, and one open pipe segments prior to the settler 140. The length of each static mixer and open pipe segments may various according to the process need. The use of alternating mixers and open pipes is believed to improve separation of the phases by providing additional residence time for droplet coalescence. With this configuration, the multi-phase fluid system may be mixed at one mixing intensity in the mixing vessel 110, and mixed at least at a second mixing intensity less than the first mixing intensity in the static mixers 132. Alternatively, the static mixer segments 132 may comprise different zones of decreasing mixing intensities before reaching the settler 140.

The extraction and separation method described in the invention has been found to work exceptionally well on extracting polymer residue, such as catalysts, from polymer cements, particularly polymer cements of hydrogenated polymerized conjugated dienes. For use in polymer cement residue extraction and separation, a polymer cement is introduced to a vessel 10 and then contacted with an extraction fluid, thereby creating a two-phase two-layer extraction fluid/polymer cement mixture. The two-phase mixture is then mixed at a mixing intensity, then mixed at a second mixing intensity less than the first mixing intensity before allowing the two-phase mixture to settle and separate.

The polymers may be hydrogenated or epoxidized polymers and have number average molecular weight of about 1,000 to about 400,000, or higher, preferably about 50,000 to about 200,000 as measured by gel permeation chromatography. The polymer cements may also be block copolymers of monovinyl aromatic and conjugated diene, such as ABA linear copolymers where A is a monovinyl aromatic and B is a conjugated diene. Conjugated diene containing polymers which can be used in this invention include liquid, semi-liquid, and solid homopolymers and copolymers of conjugated dienes in which the monomer addition can be in the 1,2 mode or the 1,4 mode and combinations thereof. More particularly, the polymers to be modified according to this invention include the homopolymers of conjugated dienes, and the copolymers of conjugated dienes and monovinylarene monomers.

The copolymers useful in this invention generally include random, graft, block, linear teleblock, and radial teleblock copolymers, including those containing random and tapered block segments, and mixtures thereof, the polymers having a conjugated diene/monovinylarene weight ratio of between about 25/75 and about 95/5. A more preferable range of conjugated diene/monovinylarene weight ratios is from between about 45/55 and about 90/10.

Conjugated diolefins for use in the present invention may be polymerized anionically and includes those conjugated diolefins containing from about 4 to about 12 carbon atoms such as 1,3-butadiene, isoprene, piperylene, methylpentadiene, phenylbutadiene, 2,3-dimethyl-1,3-butadiene, 3,4-dimethyl-1,3-hexadiene, 4,5-diethyl-1,3-octadiene, 3-butyl-1,3-octadiene, 2-phenyl-1,3-butadiene, and the like, and mixtures thereof. Conjugated diolefins containing from 4 to about 8 carbon atoms are preferred for use in such polymers, most preferably 1,3-butadiene, isoprene, and combinations thereof.

The monovinylarene monomers normally contain from about 8 to about 20 carbon atoms per molecule and can contain alkyl, cycloalkyl, and aryl substituents, and combinations thereof such as alkylaryl, in which the total number of carbon atoms in the combined substituents is generally not greater than 12. Monovinylarene monomers can be used in the practice of the present invention are exemplified by styrene or styrene derivatives inclusive of p-methylstyrene, p-ethylstyrene, t-butylstyrene, and can include various alkyl-substituted styrenes, alkoxy-substituted styrenes, 2-vinyl pyridine, 4-vinyl pyridine, vinyl naphthalene, alkyl-substituted vinyl naphthalenes and the like. Examples of styrene and styrene derivatives monovinylarene monomers include: alpha-methylstyrene, 3-methylstyrene, 4-n-propylstyrene, 4-cyclohexyl-styrene, 4-dodecylstyrene, 2-ethyl-4-benzylstyrene, 4-p-tolylstyrene, 4-(4-phenyl-n-butyl)-styrene, 1-vinylnaphthalene, 2-vinylnaphthalene, and the like.

Anionic polymerization of conjugated diene hydrocarbons with lithium initiators is well known as described in U.S. Pat. Nos. 5,543,472, 4,039,503 and Re. 27,145, which are incorporated herein by reference to the extent not inconsistent with the invention. Polymerization commences with an anionic polymerization initiator such as Group I-A metals, their alkyls, amides, silanolates, napthalides, biphenyls and anthracenyl derivatives. Particularly effective anionic polymerization initiators are organolithium compounds having the general formula Rli_{N}, wherein R is an aliphatic, cycloaliphatic, aromatic or alkyl-substituted aromatic hydrocarbon radical having from 1 to about 20 carbon atoms; and N is an integer of 1 to 4. Of particular use as initiators are monolithium, dilithium, or polylithium initiators that build a living polymer at each lithium site.

Anionic polymerization is terminated by addition of a component that removes the lithium. For example, termination with water removes the lithium as lithium hydroxide and termination by addition of an alcohol removes the lithium as a lithium alkoxide. The polymerization is preferably terminated by utilizing an alcohol-terminating agent, but may be used with other terminating agents, such as hydrogen. The termination of living anionic polymers to form functional end groups is further described in U.S. Pat. Nos. 4,417,029, 4,518,753, 4,753,991, and 5,143,990 which are herein incorporated by reference to the extent not inconsistent with the invention.

Following termination, the polymers of use in the present invention may be hydrogenated or epoxidized to reduce unsaturation of the polymerized conjugated diene, particularly when the conjugated diene is butadiene and/or isoprene. Hydrogenation of at least 90%, preferably at least 95%, of the unsaturation in butadiene polymers is achieved with nickel and cobalt catalysts as described in U.S. Pat. Nos. Re. 27,145, 4,970,254, and 5,543,472 which are incorporated by reference herein to the extent not inconsistent with the invention. Examples of epoxidized diene polymers and methods of their production are found in U.S. Pat. Nos. 5,229,464 and 5,247,026, which are herein incorporated by reference to the extent not inconsistent with the invention.

The termination and hydrogenation steps result in release of fine particles of lithium bases, nickel, cobalt, and aluminum that must be separated from the polymer. The lithium bases may be separated before the hydrogenation step, or they may be separated with the nickel and aluminum after hydrogenation. Conventional methods of separation after termination and/or hydrogenation are to either disperse acids, such as peracids, carboxylic acids, and mineral acids, into the polymer cement or to disperse the polymer cement into acids. Both conventional processes involve high intensity mixing for a period of time, followed by allowing the material to settle and separate. High intensity mixing, even at volume ratios such that the bulk of the acid is continuous with fully dispersed cement drops, leads to dispersed aqueous acid in the polymer cement and, even after settling times of 120 minutes or greater, the entrained acid remains in the polymer cement. Additionally, for such processes, it is preferable to use very low acid to cement ratios so that more cement can be treated in each batch, however, low acid to cement process ratios tend to have higher entrainments than processes with more balanced ratios. It has been found that any nickel, cobalt and/or lithium successfully extracted to the acid are returned to and entrapped in the cement by way of the entrained acid. Therefore, the entrained acid reduces extraction efficiency and leaves residuals in the final polymer product.

While the following description for one exemplary embodiment of a process for step-down mixing intensity is provided herein to illustrate the invention herein, the exemplary embodiment shown should not be used to limit the scope of the invention.

The process of the present invention has been surprisingly and unexpectedly found to change the results of this conventional separation, or wash step. After termination or hydrogenation is complete, an aqueous acid solution, preferably having an acid concentration of between about 0.1 wt % and about 3 wt % of an mineral acid, is added to a vessel containing a polymer cement, wherein the two immiscible fluids create a two-phase acid/polymer cement system. The two-phase mixture preferably has an acid to cement volume ratio of about 0.1 to about 1.0. Preferably, the polymer cement has a viscosity from about 25 cps to about 1500 cps. Preferably, the aqueous acid solution has an acid concentration of 0.1-30% wt of the mineral acid.

The immiscible fluids are mixed at a first mixing intensity, that is high enough to ensure an effective extraction between the acid and the polymer cement phases, preferably with a mechanically agitated mixer with impeller tip rate from about 25 to about 3000 revolutions per minute (rpm) for conjugated diene polymer cements for between about 1 minute to about 60 minutes. However, the choice of the mixing intensity and mixing time will depend on the equipment and viscosity of the cement. The acid/polymer cement two-phase mixture is then mixed at a second mixing intensity lower than the first mixing intensity. The second mixing intensity is preferably an intensity that allows the formation of large droplets that can provide for lower entrainment of extractable material in the phases.

At each mixing intensity in the step-wise reduction process, mixing is performed for a period of time to allow the formation of large droplets. An initial, or first, mixing time is preferably between about 1 minute and about 60 minutes. Subsequent mixing times are preferably shorter and can range from less than about one tenth of one minute to about twenty minutes for polymer cements. Mixing rates and mixing times will vary due to the viscosity of the polymer cement and dimensions of the equipment used, but generally, polymer cements of conjugated dienes can be mixed within the parameters stated above.

The step-wise mixing rate reduction method may further comprise mixing the multi-phase fluid system at a third mixing intensity less than the second mixing intensity and still further comprise mixing the multi-phase fluid system at a fourth mixing intensity less than the third mixing intensity before allowing the two immiscible fluids to settle. It is contemplated by the invention, that any number of step-wise reductions may be performed by this process to improve separation as long as the subsequent mixing steps are a step-wise reduction from the previous mixing intensity. The difference in the step-wise reductions may be equivalent or variable depending on the desired separation.

After mixing, the two-phase mixture is allowed to settle to allow the acid to separate from the polymer cement. For practical purposes, the settling is usually complete in less than 60 minutes, and may occur in less than 1 minute, after which time no more appreciable amount of entrained fluid will be removed.

An additional advantage to the step-wise reduction of mixing intensities is the reduction or elimination of a rag layer. Conventional extraction methods can result in a certain amount of polymer that forms an emulsion with the acid. Upon settling, this highly stable emulsion settles between the cement layer and the acid layer and is called a “rag layer.” The acid will not settle out of the rag layer, and the acid is in too high a concentration for the polymer in this layer to be of any use. Thus, reduction of the rag layer increases the product yield, another significant advantage for commercial production.

The significant and unexpected results of high intensity mixing and low intensity mixing can be explained by the formation of droplets by entrained material. When the droplets are small, such as in high intensity mixing, extraction of material is rapid but the droplets have difficulty separating from the phase resulting in slow settling and high entrainment. When the droplets are large, such as in low intensity mixing, the extraction process is slow, but the droplets can settle faster resulting in lower entrainment than expected. It is believed that, by applying the step-wise mixing rate reduction method of the present invention, smaller droplets with good extraction properties coalesce into larger droplets and thereby accelerate phase separation in the mixer/settler.

The method of the invention uses the mixer/settler in an unconventionally manner to achieve fast extraction followed by increasing droplet size within a very short time as the mixing intensity is reduced in a step-wise fashion. Droplet size distribution in a mixing system is determined by dynamic equilibrium between two competing mechanisms, droplet breakup and droplet coalescence. As mixing intensities increase, droplet breakup becomes dominant for a certain period, as high mixing intensity or shearing forces disperse large droplets into smaller droplets. However, as droplets get smaller, the number of droplets increase in the mixing intensity system which leads to more and more droplet coalescence, and the system eventually reaches a new equilibrium of smaller droplets. The smaller droplets formed at high mixing intensity have a fast extraction rate but settle slower, thereby resulting in phases with high entrainment. On the other hand, as mixing intensities decrease, droplet coalescence becomes dominant for a certain period, because the driving forces for droplet breakup suddenly reduce while coalescence of small droplets continues. This leads to a rapid shift of equilibrium to larger droplets that settle fast and have a low entrainment. The prior art of the mixer/settler design did not take advantage of the competing processes of droplet breakup and coalescence as mixing intensity is increased or decreased. Typically only one of these concerns is addressed by performing either a high intensity mix for fast extraction or a low intensity mix for low entrainment and quick separation in the prior art of the mixer/settler design.

The inventors have discovered that a step-wise reduction of mixing intensities increases the droplet size and decreases entrainment while providing unexpectedly faster separation times. The first mixing intensity controls the extraction process by promoting the formation of small droplets. The second or further step-wise reduction in mixing intensity allow the formation of larger droplets at each reduction in mixing intensity to improve phase separation and lower entrainment. A short pause preferably occurs at each reduction in mixing intensity to allow the coalescence to form droplets as large as possible in relation to the reduced mixing intensity.

The invention is further described by the following examples.

### EXAMPLES

The process according to the invention performed a series of extractions of polymer residue. The extractions were conducted in a 4-liter laboratory extraction unit that consisted of a jacketed glass vessel with a hot water bath connected to the jacket. Two flat-blade 2.5 inch diameter impellers, each containing six blades, were positioned in the vessel to provide mixing or agitation. Four baffles of 3/4-inch width were placed radially at 90° from one another inside the vessel. Nickel/cobalt oxidation was accomplished by delivering 3% mol oxygen/97% mol nitrogen via a 1/8-inch tube placed just below the lower flat blade turbine. The oxygen/nitrogen mix was delivered from a cylinder and metered with a rotameter.

About 2900 ml of 14 wt. % polystyrene-hydrogenated polybutadiene-polystyrene (S-EB-S) block copolymer cement having about 15 parts per million (ppm) cobalt (Co) hydrogenation catalyst was added to the vessel and mixed while heating to an extraction temperature of approximately 82° C. (180° F.). The mixer was then turned off. Then 85 wt. % phosphoric acid (H₃PO₄) was diluted directly with deionized water to form 580 ml of 1% (H₃PO₄). The acid was then heated to the extraction temperature and added to the cement to form an acid/cement ratio of 0.2. The mixer was then turned on at the desired first mixer rate for the extraction. In this example, rates refer to the rate of revolution of the impeller blade tips. Immediately after turning the mixer on, 3% mol oxygen addition was delivered to the extraction vessel at 250 milliliters per minute (ml/min) for approximately 7 minutes of mixing while maintaining a pressure of 25 psig in the extractor with a backpressure regulator.

Two runs were performed under different mixing processes, Run 1056 was mixed using conventional mixing S methods known in the art and Run 1072 was mixed using the mixing method according to the invention. Mixing was discontinued and settling of the phases was allowed to occur. Acid entrainment was measured experimentally by centrifuging a sample of polymer cement and weighing the amount of acid separated from the cement.

In the first run under these conditions, Run 1056, the cement/acid mixture was mixed for 60 minutes, then mixing was discontinued and the mixture was allowed to settle. No acid settling was observed after approximately 40 minutes. The acid entrainment for Run 1056 was determined to be about 20% by weight (wt. %). In the second run, Run 1072, the cement/acid mixture was mixed for 60 minutes, and then the step-wise reduction mixing was performed. The cement/acid mixture was first mixed at 1000 rpm for 1 minute and 25 ml of acid was observed to have separated, then the mixing rate was reduced step-wise to 700 rpm and mixed for 2 minutes and 50 ml of acid was observed to have separated, and finally reduced step-wise to a mixing rate of about 400 rpm and mixed for 3 minutes and 100 ml of acid was observed to have separated. Once the mixer was discontinued, the volume of separated acid was measured at separate time variables. At the time when the mixer was turned off, time is zero, and 100 ml of acid was observed to have separated. At 12 seconds (0.2 minutes), it was observed that 200 ml of acid had separated and at 24 seconds (0.4 minutes) and higher, 250 ml of acid had been observed to have separated. The acid entrainment for Run 1072 was measured and determined to be 13 wt. W. The experimental data collected for the two runs is shown in Table 1 below.

TABLE 1
Separation Times for Step-Wise Reduction Mixing
and Conventional Mixing.

| | Impeller Rat | Time Elapsed | Acid Separation |
|---|---|---|---|
| RUN | (RPM) | (min) | (ml) |
| 1056 | 2000 | 60 | N/A |
| | 0 | 100 | No separation |
| 1072 | 2000 | 60 | N/A |
| | 1000 | 61 | 25 |
| | 700 | 63 | 50 |
| | 400 | 66 | 100 |
| | 0 | 66 | 100 |
| | 0 | 66.2 | 200 |
| | 0 | 66.4 | 250 |

A series of experiments were performed at different mixing rates according to the procedure. Run 1084 was performed using the step-wise reduction process as described for Run 1072 above. Runs 1052, 1074, 1076, 1078, 1082, 1086, 1088, and 2845 were performed by the conventional mixing process as described in Run 1056 above. The polymer cement/acid mixture was prepared in the same manner as described for runs 1056 and 1072. The collected data from the experimental runs was collected and is summarized in Table 2 below. The experimental data for 1056 and 1072 have been added to Table 2 for comparison.

As shown in Tables 1 and 2, rapid separation always occurred when a step-wise reduction in mixing rate is used according to the invention. In particular, Runs 1052, 1056, and 1072 clearly show a significant improvement in separation at high mixing rates. When the step-wise reduction process was not performed at higher mixing rates in Runs 1052 and 1056, there was no appreciable separation occurring. However, Run 1072 was performed under the same conditions except mixed by the step-wise reduction process, separation was achieved in less than a minute with less entrainment than 1052 and 1056.

TABLE 2
Separation Times for Step-Wise Reduction
Mixing and Conventional Mixing.

| | | | | | | % Wt. |
|---|---|---|---|---|---|---|
| | Impeller | Mixing | | | | Acid |
| | Rate | Time | Step-wise | Separation | Acid | Entrain- |
| RUN | (RPM) | (min) | reduction | Time (min) | Ratio | ment |
| 1052 | 2410 | 60 | N | No separation | 0.2 | 20 |
| 1056 | 2000 | 60 | N | No separation | 0.2 | 20 |
| 1072 | 2000 | 60 | Y | <1 min | 0.2 | 12.7 |
| 1074 | 1500 | 30 | N | <1 min | 0.2 | 2.3 |
| 1076 | 1500 | 5 | N | 15 | 0.2 | 2.3 |
| 1078 | 1500 | 30 | N | 30 | 0.2 | 1.7 |
| 1082 | 1500 | 30 | N | 2 | 0.2 | 1.7 |
| 1084 | 1500 | 30 | Y | 3 | 0.2 | 1.6 |
| 1086 | 1500 | 2 | N | 15 | 0.2 | 3.0 |
| 1088 | 1500 | 30 | N | 19 | 0.2 | 1.6 |
| 2485 | 1500 | 1 | N | 15 | 0.2 | 3.6 |

As shown in Runs 1082 and 1084, the acid entrainment for runs with the step-wise reduction in mixing rate are at least as low as the entrainments of runs done at the same mixing rate and mixing time but without the step-wise reduction in mixing rates. At mixing rates of approximately 1500 rpm, the separation time without the step-wise reduction was longer than 15 minutes for the majority of the runs. Table 1 also clearly shows an increase in acid entrainment at a lengthy separation time as the mixing time is reduced for a mixing rate of 1500 rpm. Therefore, Tables 1 and 2 clearly show improved separation for the polymer cements under conditions when intensive mixing produce very long separation times.

While foregoing is directed to the preferred embodiment of the present invention, other and further embodiments of the invention may be devised without departing from the basic scope thereof, and the scope thereof is determined by the claims that follow.

We claim:

1. A method for extracting a component from a fluid, comprising:
forming a multi-phase fluid system comprising at least a first phase having at least one extractable component and a second phase having an attraction for the extractable component;
mixing the multi-phase fluid system at a first mixing intensity;
mixing the multi-phase fluid system at least at a second mixing intensity less than the first mixing intensity; and
allowing the multi-phase fluid system to settle.

2. The method of claim 1, further comprising mixing the multi-phase fluid system at a third mixing intensity less than the second mixing intensity before allowing the multi-phase system to settle.

3. The method of claim 2, further comprising mixing the multi-phase fluid system at a fourth mixing intensity less than the third mixing intensity before allowing the multi-phase system to settle.

4. The method of claim 1, wherein the mixing is accomplished by a variable rate mixer.

5. The method of claim 1, wherein mixing is accomplished by one or more in-line mixing elements.

6. The method of claim 5, wherein the in-line mixing elements comprise at least one static mixer.

7. The method of claim 1, wherein the mixing is accomplished by a variable or constant rate mixer and one or more in-line mixing elements.

8. The method of claim 7, wherein the in-line mixing elements comprise at least one static mixer.

9. The method of claim 1, wherein the mixing occurs in a batch process.

10. The method of claim 1, wherein the mixing occurs in a continuous process.

11. The method of claim 1, wherein mixing intensity is varied by mixer impeller tip rate, and the first mixing intensity is from about 25 rpm to about 3000 rpm.

12. The method of claim 11, wherein the multi-phase mixture is mixed at the first mixing intensity from about 1 minute to about 60 minutes.

13. The method of claim 11, wherein the second mixing intensity is between about 20% and about 90% of the first mixing intensity.

14. The method of claim 13, wherein the multi-phase mixture is mixed at the second mixing intensity from between about 0.1 minutes and about 20 minutes.

15. A method for extracting and separating impurities from polymer cements, comprising:
introducing a polymer cement to a vessel;
contacting the polymer cement with an extraction fluid selected from the group consisting of an acid solution, a caustic solution, and combinations thereof, to form a multi-phase mixture;
mixing the multi-phase mixture at a first mixing intensity;
mixing the multi-phase mixture at least at a second mixing intensity less than the first mixing intensity; and
allowing the multi-phase mixture to settle.

16. The method of claim 15, wherein the polymer cement comprises a conjugated diene polymer or block copolymer having a number average molecular weight from about 1000 to about 400,000.

17. The method of claim 15, wherein the mixing is accomplished by a variable rate mixer.

18. The method of claim 15, wherein the mixing is accomplished by one or more in-line mixing elements.

19. The method of claim 18, wherein the in-line mixing elements comprise at least one static mixer.

20. The method of claim 15, wherein the mixing is accomplished by a variable or constant rate mixer and one or more in-line mixing elements.

21. The method of claim 20, wherein the in-line mixing elements comprise at least one static mixer.

22. The method of claim 15, further comprising mixing the multi-phase mixture at a third mixing intensity less than the second mixing intensity before allowing the multi-phase mixture to settle.

23. The method of claim 22, further comprising mixing the multi-phase mixture at a fourth mixing intensity less than the third mixing intensity before allowing the multi-phase mixture to settle.

24. The method of claim 15, wherein mixing intensity is varied by mixer impeller tip rate, and the first mixing intensity is from about 25 to about 3000 rpm.

25. The method of claim 24, wherein the second mixing intensity is from about 20% to about 90% of the first mixing intensity.

26. The method of claim 24, wherein the multi-phase mixture is mixed at the first mixing intensity from about 1 to about 60 minutes.

27. The method of claim 25, wherein the multi-phase mixture is mixed at the second mixing intensity from between about 0.1 minutes and about 20 minutes.
